(19) United States
(12) Patent Application Publication
(10) Pub. No.: US 2013/0271544 A1
(43) Pub. Date: Oct. 17, 2013

(54) CUTTING DEVICE AND RECORDING APPARATUS

(71) Applicant: SEIKO EPSON CORPORATION, Tokyo (JP)

(72) Inventors: Yasushi YAJIMA, Nagano-ken (JP); Nobuaki SAKAI, Shiojiri-shi (JP)

(73) Assignee: SEIKO EPSON CORPORATION, Tokyo (JP)

(21) Appl. No.: 13/847,753

(22) Filed: Mar. 20, 2013

(30) Foreign Application Priority Data
Apr. 16, 2012 (JP) 2012-092676

(51) Int. Cl. B41J 11/70; B26D 7/00

(52) U.S. Cl. CPC B41J 11/70; B26D 7/00
USPC 347/104; 83/111

(57) ABSTRACT

A cutting device includes: a first guide portion that supports a sheet as a target to be cut; and a pair of cutting blades that cuts the sheet by performing a shearing operation on the sheet when the pair of cutting blades is in a state of pinching a cutting-target part of the sheet supported by the first guide portion from both sides thereof. The pair of cutting blades is configured of a fixed blade and a movable blade. The first guide portion supports the sheet in a manner in which the sheet is moved along a main transport surface that is so set as to pass through between the fixed blade and the movable blade when the fixed blade and the movable blade are not being engaged, and also supports the sheets so that the sheet can move from the main transport surface.

### BACKGROUND

1. Technical Field

The present invention relates to cutting devices that cut a target by shearing operation and recording apparatuses provided with the stated cutting devices.

2. Related Art

In general, ink jet printers are widely known as a recording apparatus that performs recording on a target. Of these printers, there exists such a printer that performs printing (recording) by ejecting ink (liquid) from a recording head (recording unit) onto a sheet (target), and thereafter cuts and discharges the sheet. For example, in a printer disclosed in JP-A-2009-226846, a sheet on which printing has been performed is cut with a pair of cutting blades that is so provided as to sandwich a transport path of the sheet and that performs shearing operation.

There is a case in which a sheet on which printing has been performed deforms during being transported in a manner such that a sheet end as an end portion of the sheet on the downstream side in a transport direction swings in an up-down direction, or the like. Accordingly, in the case where a sheet is cut by shearing operation with a pair of cutting blades, when taking into consideration such deformation of a sheet during the sheet being transported, the cutting blades are needed to be disposed with a space in which both the cutting blades are distanced from a transport plane (reference plane) in the up-down direction.

Accordingly, like in the printer disclosed in JP-A-226846, in the case where one of the paired cutting blades is an immovable fixed blade during a shearing operation and the other one is a movable blade that relatively moves with respect to the fixed blade during the shearing operation, the sheet is moved being pushed by the movable blade toward the fixed blade side and is cut in a slanting posture with respect to a shearing direction formed by the fixed blade and the movable blade along the vertical direction. This has raised a risk such that the sheet is cut like being torn off by the paired cutting blades and appearance of the sheet is spoiled in some case.

The above problem is not limited to the ink jet printer equipped with the paired cutting blades, and is substantially common to cutting devices that cut a target by shearing operation and recording apparatuses provided with the stated cutting devices.

### SUMMARY

An advantage of some aspects of the invention is to provide a cutting device and a recording apparatus in which a target can be finely cut by shearing operation.

A cutting device according to an aspect of the invention includes: a support section that supports a target to be cut; and a pair of cutting blades that cuts the target by performing a shearing operation on the target when the pair of cutting blades is in a state of pinching a cutting-target part of the target supported by the support section from both sides thereof. Further, the pair of cutting blades is configured of a first cutting blade that is immovable during the shearing operation and a second cutting blade that is movable during the shearing operation; the support section supports the target in a manner in which the target is moved along a reference plane that is so set as to pass through between the first and second cutting blades when these two blades are not being engaged, and also supports the target so that the target can move from the reference plane when the cutting-target part of the target is pushed from a direction intersecting with the reference plane; and the pair of cutting blades is provided so that a shearing direction thereof against the target intersects slantingly with the reference plane.

For example, in the case where, taking into consideration the deformation or the like of a target, a pair of cutting blades and the reference plane on which the target is supported are distanced from each other, the target is moved to a position different from the reference plane being pushed by one of the paired cutting blades when the target is to be cut by the paired cutting blades performing the shearing operation. In this case, with the configuration of this aspect, the pair of cutting blades is provided being slanted so that its shearing direction is slanted with respect to the reference plane. Accordingly, in comparison with a case in which the pair of cutting blades is provided with its shearing direction perpendicular to the reference plane, it is possible to make the target and the shearing direction form an angle closer to a right angle. As a result, the target can be cut finely by the shearing operation.

In the cutting device of this aspect of the invention, it is preferable that, of the pair of cutting blades, the first cutting blade be provided on the upper side of the reference plane and the second cutting blade be provided on the lower side of the reference plane in the vertical direction.

With the above configuration, even if a cut-off piece of the target having been cut off remains staying on the cutting blades, since the second cutting blade which is movable during the shearing operation is arranged on the lower side in the vertical direction, it is easier to shake off the target than in a case in which the first cutting blade which is immovable during the shearing operation is arranged on the lower side in the vertical direction. Accordingly, a risk that the target having been cut off is held by the paired cutting blades can be reduced.

In the cutting device of this aspect of the invention, it is preferable for the second cutting blade to be formed so that a surface that intersects with a surface extending along the shearing direction in a cutting edge of the second cutting blade is slanted with respect to the reference plane.

With the above configuration, it is possible to reduce a risk that a target having been cut off is held by the second cutting blade in comparison with a case in which the surface that intersects with the surface extending along the shearing direction in the cutting edge of the second cutting blade is parallel to the reference plane.

In the cutting device of this aspect of the invention, it is preferable for the pair of cutting blades to be provided so that the second cutting blade is arranged at a position farther distanced from the support section than the first cutting blade when the two cutting blades are engaged with each other.

For example, in a case in which the pair of cutting blades is provided so that the second cutting blade is arranged at a position closer to the support section than the first cutting blade when the two cutting blades are engaged with each other, the second cutting blade performs the shearing operation while pushing a part of the target which is on the support section side with respect to a cutting-target part of the target when the target is cut. In other words, a part of the target which is on the opposite side of the cutting-target part to the support section side, or a part of the target to be cut off from the target which is on the side where the target is supported by the support section will not be pushed by the movable second cutting blade. Therefore, there has been a possibility that a part of the target of the side having been cut off remains sticking to the first cutting blade. In this respect, according to the configuration of this aspect of the invention, the pair of cutting blades is provided so that the second cutting blade is arranged at a position farther distanced from the support section than the first cutting blade when the two cutting blades are engaged with each other. Accordingly, when the target is to be cut, the second cutting blade can push a part of the target on the side to be cut off where the target is not supported by the support section, and prevent the part of the target on the side to be cut off from remaining while the part thereof sticking to the first cutting blade. Therefore, the target can be more appropriately cut than in the case where the pair of cutting blades is provided so that the second cutting blade is arranged at a position closer to the support section than the first cutting blade.

It is preferable for the cutting device of this aspect of the invention to further include an angle changing mechanism that changes a slant angle of the shearing direction formed by the pair of cutting blades against the target.

The optimum shearing direction formed by the pair of cutting blades against the target varies according to the types of the target, or the like. In this respect, according to the configuration of this aspect, it is possible to change the slant angle of the shearing direction of the paired cutting blades with the angle changing mechanism. This makes it possible to change the shearing direction for each type of the target, for example, so that the target can be cut further finely by the shearing operation.

In the cutting device of this aspect of the invention, it is preferable for the pair of cutting blades to be provided so that, when the target that has been pushed and moved by the second cutting blade makes contact with the first cutting blade, the shearing direction is perpendicular to the surface of the target which is in contact with the second cutting blade.

With the above configuration, it is possible to make the shearing direction perpendicular to the surface of the target when the cutting blades cut the target through shearing operation. This makes it possible to further reduce a risk that the target is torn off by the pair of cutting blades.

A recording apparatus according to an aspect of the invention includes the cutting device in the above-described configuration, a recording unit that performs recording on the target, and a transport section that transports the target so that the target is moved between the recording unit and the cutting device.

According to the above configuration, it is possible to obtain the same action effect as that of the cutting device according to the aforementioned aspect of the invention.

### BRIEF DESCRIPTION OF THE DRAWINGS

The invention will be described with reference to the accompanying drawings, wherein like numbers reference like elements.

FIG. 1 is a schematic diagram of a printer according to an embodiment of the invention.

FIG. 2 is a schematic cross-sectional view of a cutting mechanism at the time of non-cutting.

FIG. 3 is a schematic cross-sectional view of the cutting mechanism at the time of cutting.

FIG. 4 is a block diagram of a controller.

FIG. 5A is a schematic diagram of a sheet at the time of front-face printing, FIG. 5B is a schematic diagram of a sheet at the time of reverse-face printing, FIG. 5C is a schematic diagram of a sheet at the time of trailing-edge cutting, and FIG. 5D is a schematic diagram of a sheet at the time of leading-edge cutting.

FIG. 6 is a schematic cross-sectional view illustrating a first variation on the cutting mechanism.

FIG. 7 is a schematic cross-sectional view illustrating a second variation on the cutting mechanism.

FIG. 8 is a schematic cross-sectional view illustrating a third variation on the cutting mechanism.

### DESCRIPTION OF EXEMPLARY EMBODIMENTS

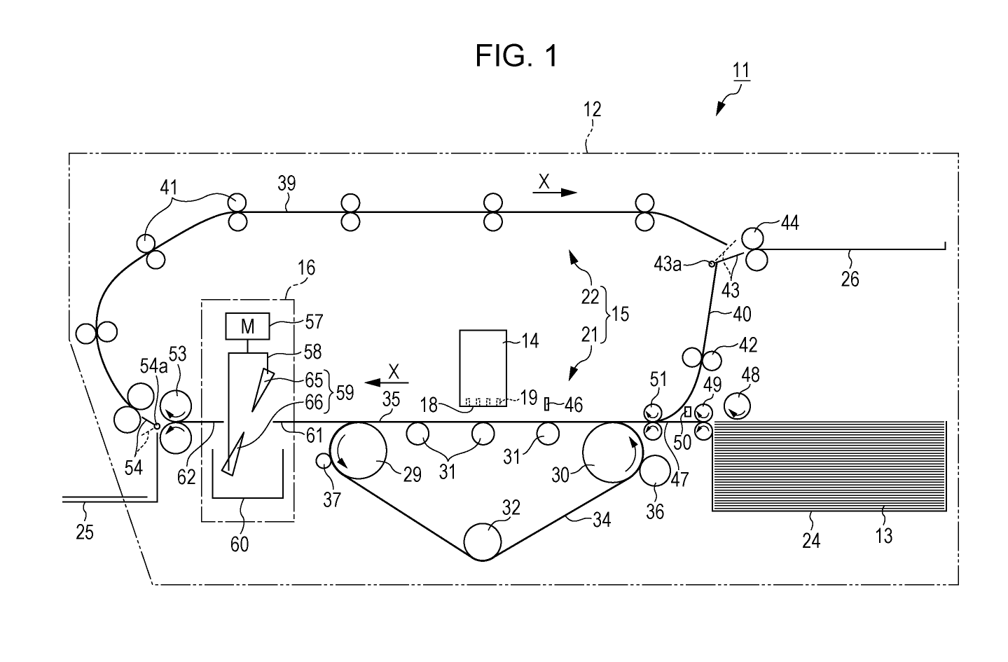

Hereinafter, an embodiment that has embodied the invention in an ink jet printer which is a type of recording apparatus (hereinafter, referred to as a “printer”), will be described with reference to FIG. 1 through FIG. 5D.

As shown in FIG. 1, a printer 11 as a recording apparatus according to an embodiment of the invention includes a main apparatus case 12 having a box-like shape. At an approximately central location within the main apparatus case 12, a recording head 14 (recording unit) that ejects ink (liquid) onto a sheet 13 as a target is fixedly disposed, and a sheet transport mechanism 15 as a transport section for transporting the sheet 13 is disposed circularly surrounding the recording head 14. Further, a cutting mechanism 16 as a cutting device for cutting the sheet 13 is provided in a transport path of the sheet 13 that is transported by the sheet transport mechanism 15.

In a nozzle formation surface 18 of the recording head 14, while being aligned along a direction that intersects with a transport direction X of the sheet 13 (direction indicated by an arrow in FIG. 1), a large number of nozzles 19 are formed across the length of width of the sheet 13. In other words, the recording head 14 of this embodiment is what is known as a full-line type line head formed in a shape that corresponds to the entire width of the sheet 13 in a width direction orthogonal to the transport direction X of the sheet 13 (direction orthogonal to the paper surface of FIG. 1).

Note that a plurality of ink cartridges (not shown) that respectively store different colors of ink are connected to the recording head 14. Inks stored in the ink cartridges are supplied to the recording head 14 as needed during the printing at a pressure adjusted to a predetermined pressure.

The sheet transport mechanism 15 includes a printing transport unit 21 provided at a position opposed to the nozzle formation surface 18 of the recording head 14 and a reverse-printing transport unit 22 configured to transport the sheet 13 having been transported by the printing transport unit 21 to the printing transport unit 21 again. In addition, in the periphery of the sheet transport mechanism 15, there are provided a sheet supply tray 24 that accommodates a plurality of sheets 13 of single sheet form being laminated, a discharge tray 25 that accommodates the sheet 13 after printing, and a temporary accommodation tray 26 that temporarily accommodates the sheet 13 transported in the reverse-printing transport unit 22.

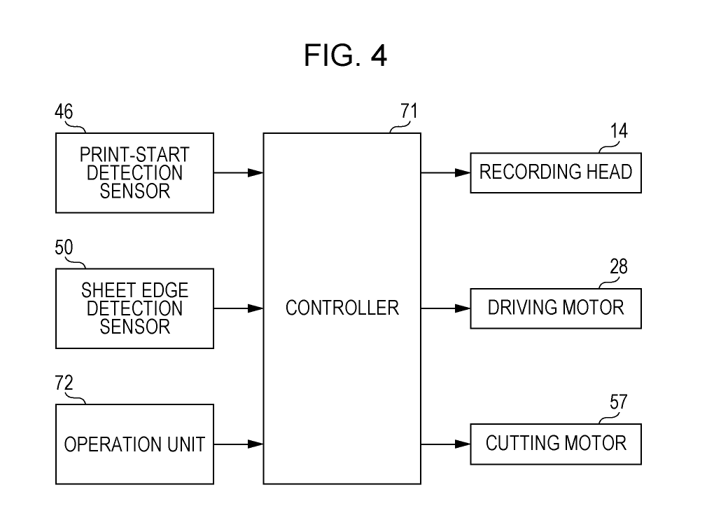

The printing transport unit 21 includes a drive roller 29 that is disposed in a rotatable manner driven by a driving motor 28 (see FIG. 4), and a driven roller 30 that is disposed at the same height as the drive roller 29. At least one (three in this embodiment) auxiliary transport roller 31 is provided in a rotatable manner at a position between the drive roller 29 and the driven roller 30. Note that the drive roller 29, the driven roller 30, and the auxiliary rollers 31 are provided so that the upper surfaces on the recording head 14 side of the respective rollers have the same height. In addition, a tension roller 32 is rotatably provided at a position on the lower side of the auxiliary rollers 31.

Further, the drive roller 29, the driven roller 30, the auxiliary rollers 31, and the tension roller 32 are provided extending in the width direction, and an endless transport belt 34 is stretched upon between these rollers with tension being applied in a circulatable manner. In the transport belt 34, the upper surface of a portion that is supported to be leveled by the auxiliary rollers 31 from the lower side between the drive roller 29 and the driven roller 30 functions as a main transport surface 35.

Furthermore, a charging roller 36 is rotatably disposed corresponding to the driven roller 30 with the transport belt 34 being pinched between the circumferential surfaces thereof. Meanwhile, an electricity-removing roller 37 is rotatably provided corresponding to the drive roller 29 with the transport belt 34 being pinched between the circumferential surfaces thereof. Accordingly, the sheet 13 fed out from the sheet supply tray 24 is transported from the upstream side to the downstream side in the transport direction X in a state of being adhered and held on the main transport surface 35 of the charged transport belt 34, thereby passing through a position opposed to the nozzle formation surface 18 of the recording head 14. Subsequently, the sheet 13 on which the printing has been performed with ink ejected through the nozzles 19 is transported to the cutting mechanism 16.

The reverse-printing transport unit 22 is so provided as to connect the cutting mechanism 16 and the upstream side of the main transport surface 35 (a side of the driven roller 30 on the right end side in FIG. 1) by a first reverse guide plate 39, a second reverse guide plate 40, a plurality of auxiliary rollers 41, and a reverse gate roller 42. Between the reverse-printing transport unit 22 and the temporary accommodation tray 26, there are provided a switchback selector 43 and a switchback roller 44.

The switchback selector 43 is supported in a rotatable manner about a base end portion 43a as a fulcrum point. With the rotation of the switchback selector 43, switching of the temporary accommodation tray 26 to the first reverse guide plate 39 or to the second reverse guide plate 40 is carried out.

To be more specific, in the case where the switchback selector 43 is set at a position on the lower side (position indicated by a full line in FIG. 1), the temporary accommodation tray 26 is connected with the first reverse guide plate 39. With this, the sheet 13 that is supported by the first reverse guide plate 39 and that is transported with the rotation of the auxiliary rollers 41, is accommodated in the temporary accommodation tray 26 with a forward rotation of the switchback roller 44. On the other hand, in the case where the switchback selector 43 is set at a position on the upper side (position indicated by a dotted line in FIG. 1), the temporary accommodation tray 26 is connected with the second reverse guide plate 40. With this, the sheet 13 having been accommodated in the temporary accommodation tray 26 is transported to the second reverse guide plate 40 side with a reverse rotation of the switchback roller 44, and is transported to the main transport surface 35 with rotation of the reverse gate roller 42.

Further, a print-start detection sensor 46 is provided at a position which is on the upper side of the main transport surface 35 and which is on the sheet tray 24 side with respect to the recording head 14. The print-start detection sensor 46 is used to obtain a start point from which the quantity of transport is counted when the sheet 13 is transported from the position where the print-start detection sensor 46 is provided to a print position immediately under the nozzle formation surface 18 of the recording head 14.

Furthermore, between the sheet supply tray 24 and the printing transport unit 21, there is provided a sheet supply guide plate 47 that guides the sheet 13 from the sheet supply tray 24 to the upstream side of the main transport surface 35. At the upper side of the sheet supply tray 24, there is provided a pickup roller 48 for taking out the sheet 13 that is accommodated on the uppermost position of the sheet supply tray 24. In addition, at a connecting portion between the sheet supply tray 24 and the sheet supply guide plate 47, there is provided a pair of separation rollers 49 for feeding out the sheet 13 one by one through separating the sheets 13 that have been picked up being overlapped each other due to friction.

Moreover, at a position above the sheet supply guide plate 47, there are provided a sheet edge detection sensor 50 that detects the sheet 13 having passed through the pair of separation rollers 49 and a pair of gate rollers 51 that is driven when the sheet 13 is fed out from a position on the sheet supply guide plate 47 to the main transport surface 35. Then, the pickup roller 48, the pair of separation rollers 49, and the pair of gate roller 51 respectively rotate in the directions (directions indicated by arrows in FIG. 1) each of which enables the sheet 13 to be transported to the main transport surface 35 side, whereby the sheet 13 accommodated in the sheet supply tray 24 is fed out onto the main transport surface 35.

Note that between the cutting mechanism 16 and the discharge tray 25, there are provided a pair of discharge rollers 53 for discharging the sheet 13 to the discharge tray 25 and a path selector 54 for selecting a transport path of the sheet 13 fed out by the pair of discharge rollers 53. The path selector 54 is rotatably supported about a base end portion 54a as a fulcrum point, and the transport path of the sheet 13 is switched with the rotation of this path selector 54. In other words, in the case where the pair of discharge rollers 53 is rotated while the path selector 54 is being set at a position on the lower side (position indicated by a dotted line in FIG. 1), the sheet 13 is discharged to the discharge tray 25. Meanwhile, in the case where the pair of discharge rollers 53 is rotated while the path selector 54 is set at a position on the upper side (position indicated by a full line in FIG. 1), the sheet 13 is transported to the reverse-printing transport unit 22.

Next, the cutting mechanism 16 will be described in detail below.

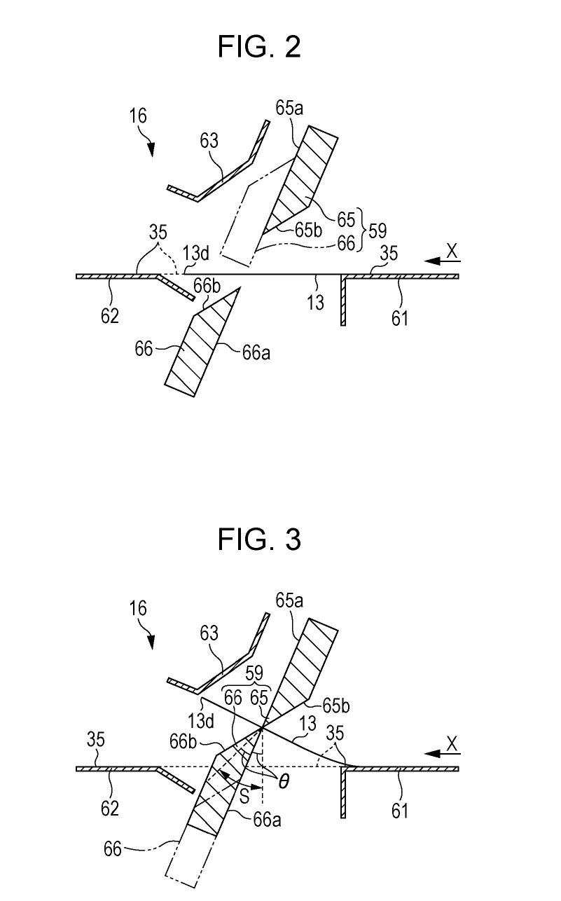

As shown in FIGS. 1 and 2, the cutting mechanism 16 includes a cutting motor 57, a cutter frame 58 connected with the cutting motor 57, a pair of cutting blades 59 supported by the cutter frame 58, and a collection tray 60 for collecting a cut-off piece of the sheet 13. The cutting mechanism 16 further includes first and second guide portions 61 and 62 that support the sheet 13 transported from the printing transport unit 21, and a third guide portion 63 provided on the upper side in the vertical direction of the first and second guide portions 61 and 62.

Note that the first and second guide portions 61 and 62 are provided with a space therebetween in the transport direction X, and also provided being flushed with the transport belt 34 so as to configure a part of the main transport surface 35 whose upper surface in the vertical direction supports the sheet 13. With this, the sheet 13 transported from the printing transport unit 21 is supported along the main transport surface 35 by the first guide portion 61, and thereafter transported along the main transport surface 35 being supported by the second guide portion 62. Accordingly, the first guide portion 61 of this embodiment functions as the support section and the main transport surface 35 functions as the reference plane.

The pair of cutting blades 59 is configured of a fixed blade 65 as the first cutting blade that is provided in an immovable manner on the upper side in the vertical direction of the main transport surface 35 and a movable blade 66 as the second cutting blade that is provided in a movable manner on the lower side in the vertical direction from the main transport surface 35. Note that the fixed blade 65 and the movable blade 66 are provided across the length in the width direction of the sheet 13 to be longer in size than the width of the sheet 13.

As shown in FIG. 2, the movable blade 66 moves between a standby position on the lower side indicated by a full line and a cutting position on the upper side indicated by a double-dot dash line, and is relatively movable with respect to the immovable fixed blade 65 at a position corresponding to the cutting position. In other words, at the time of non-shearing operation in which the fixed blade 65 and the movable blade 66 are not engaged because the movable blade 66 is located at the standby position, the fixed blades 65 and the movable blade 66 are opposed to each other sandwiching the main transport surface 35 therebetween in the vertical direction with a space between the fixed blade 65 and the main transport surface 35 and a space between the movable blade 66 and the main transport surface 35. Therefore, the main transport surface 35 is so set as to pass through between the fixed blade 65 and the movable blade 66 when the fixed blade 65 and the movable blade 66 are not being engaged with each other.

At the time of shearing operation in which the fixed blade 65 and the movable blade 66 are engaged with each other when the movable blade 66 is located at the cutting position, the movable blade 66 is so arranged as to be at a position farther distanced from the first guide portion 65 than the fixed blade 65.

In addition, the positions of the fixed blade 65 and the movable blade 66 are so arranged as to be shifted from each other in the transport direction X of the sheet 13, and the shearing direction against the sheet 13 intersects slantingly with the main transport surface 35. More specifically, the shearing direction of the fixed blade 65 and the movable blade 66 is slanted with respect to the main transport surface 35, rather than being perpendicular thereto, so that the base end side of the fixed blade 65 comes closer to the first guide portion 61 and the base end side of the movable blade 66 is distanced farther from the first guide portion 61.

It is to be noted that the shearing direction in this embodiment is a direction that is formed along a plane where sliding contact surfaces 65a and 66a, with which the fixed blade 65 and the movable blade 66 make sliding contact with each other, are positioned when the movable blade 66 moves between the standby and cutting positions, and is also a direction in which a shearing force is applied to the cutting-target sheet 13. Thus, while the movable blade 66 moves along the shearing direction, the sheet 13 being pinched between the fixed blade 65 and the movable blade 66 is sheared.

Further, a flank 66b which is a surface intersecting with a surface along the shearing direction (the sliding contact surface 66a in this case) in the cutting edge of the movable blade 66, is formed being slanted so as not to be parallel to the main transport surface 35 in a state in which the movable blade 66 is provided being slanted. Furthermore, a flank 65b which is a surface intersecting with a surface along the shearing direction (the sliding contact surface 65a in this case) in the cutting edge of the fixed blade 65, is also formed being slanted in the same manner as in the case of the movable blade 66.

The cutting motor 57 and the cutter frame 58 are connected with each other via a cam mechanism (not shown). With this, when the cutting motor 57 forwardly rotates, the movable blade 66 is made to move back and forth between the standby position and the cutting position. On the other hand, when the cutting motor 57 reversely rotates, the slant of the fixed blade 65 and the movable blade 66 is changed via the cutter frame 58 so that an angle of the shearing direction against the sheet 13 can be changed. In other words, the cutting motor 57 and the cutter frame 58 function as the angle changing mechanism that changes a slant angle of the shearing direction formed by the pair of cutting blades 59 against the sheet 13 (hereinafter, also called a “shearing direction angle”).

As shown in FIG. 3, the shearing direction angle of the paired cutting blades 59 is adjusted so as to make the shearing direction perpendicular to the surface of the sheet 13 when the movable blade 66 at the standby position moves to the cutting position side pushing the sheet 13 so that the sheet 13 and the fixed blade 65 make contact with each other. That is, a shearing force is applied to the sheet 3 in a direction perpendicular to the sheet 13 by the movable blade 66 and the fixed blade 65.

The slant angle of the shearing direction formed by the paired cutting blades 59 against the sheet 13 (shearing direction angle) can be changed within an angle range S in which the sliding contact surfaces 65a and 66a are positioned and a position where the shearing direction is perpendicular to the sheet 13 when the shearing force is applied to the sheet 13 is taken as a reference position. To be more specific, the angle range S is a range of angle in which the shearing direction slants to both sides by an angle θ being centered at the reference position; the angle θ is an angle formed between the sliding contact surface 66a and a plane perpendicular to the main transport surface 35 (for example, 20 degrees).

As shown in FIG. 4, the printer 11 is provided with a controller 71 that controls the overall operation state of the printer 11. The controller 11 is a controller that includes a CPU, a ROM, and a RAM (these are not shown), and that controls driving of the recording head 14, the driving motor 28, and the cutting motor 57 based on input information from the print-start detection sensor 46, the sheet edge detection sensor 50, and an operation unit 72 so as to perform printing and cutting.

Next, an effect of the printer 11 having the above configuration will be described hereinafter.

When the operation unit 72 is operated to input a set value of the shearing direction angle of the paired cutting blades 59, the cutting motor 57 is reversely rotated so as to change the shearing direction angle of the paired cutting blades 59 to a slant angle corresponding to the inputted set value.

When the operation unit 72 is further operated to start the printing, the sheet 13 is fed out from the sheet supply tray 24 to the printing transport unit 21, and is transported to the downstream side along the main transport surface 35. The recording head 14 performs printing by ejecting ink onto the sheet 13 at the timing when the sheet 13 passes through the position opposed to the nozzle formation surface 18.

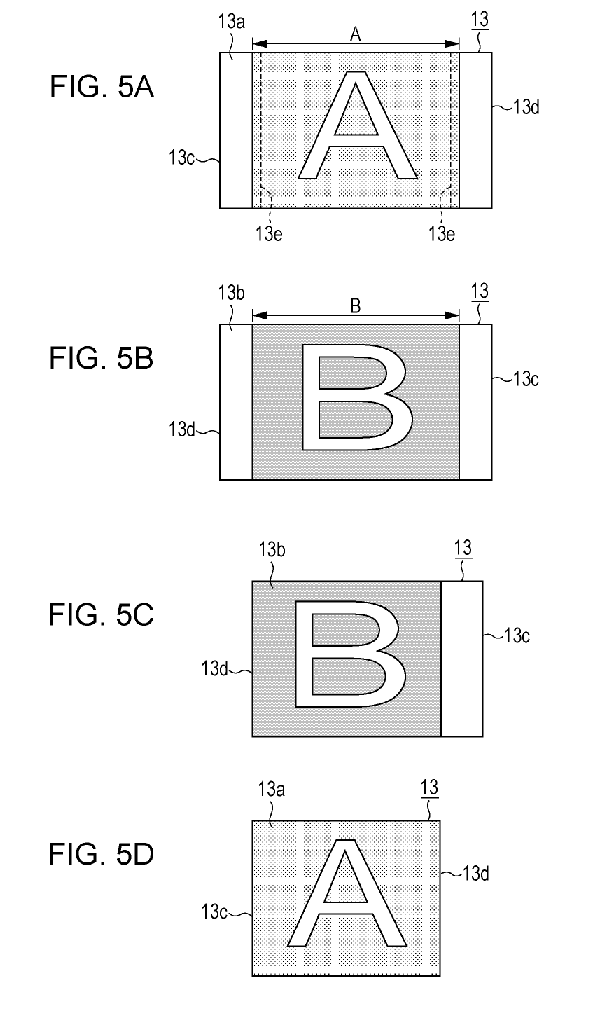

To be more specific, as shown in FIGS. 5A through 5D, the recording head 14 ejects ink onto the entirety of a print area A (see FIG. 5A) in a front face 13a of the sheet 13 opposed to the nozzle formation surface 18. Then, the printing transport unit 21 further transports the sheet 13 on which printing has been performed to the downstream side in the transport direction X so as to feed it to the cutting mechanism 16. At this time, the movable blade 66 stops its movement while being located at the standby position. Accordingly, the sheet 13 passes through the cutting mechanism 16 while being supported by the first and second guide portions 61 and 62. The path selector 54 is set to the upper side position to guide the sheet 13 to the reverse-printing transport unit 22. Subsequently, the sheet 13 is transported along the first reverse guide plate 39, and then transported to the printing transport unit 21 along the second reverse guide plate 40 after having been accommodated in the temporary accommodation tray 26.

A leading edge 13c of the sheet 13 which is positioned on the downstream side in the transport direction X when the sheet 13 is fed out from the sheet supply tray 24, comes to be positioned on the deep side of the temporary accommodation tray 26 when the sheet 13 is accommodated in the temporary accommodation tray 26. Therefore, at the time when the sheet 13 is subsequently fed out to the printing transport unit 21 while being supported by the second reverse guide plate 40, the sheet 13 is reversed in a manner in which a trailing edge 13d which is positioned on the upstream side in the transport direction X when the sheet 13 is fed out from the sheet supply tray 24 is positioned on the downstream side in the transport direction X. In addition, the sheet 13 is also reversed in a manner in which the front face 13a of the sheet 13 faces to the lower side and the reverse face 13b thereof faces to the upper side so that the front face 13a on which printing has just been performed makes contact with the transport belt 34. Then, the printing transport unit 21 transports the sheet 13 so that a reverse face 13b of the sheet 13 is opposed to the nozzle formation surface 18 of the recording head 14.

As shown in FIG. 5B, the recording head 14 performs printing by ejecting ink onto the entirety of a print area B in the reverse face 13b of the sheet 13. Note that in this embodiment, the position of the print area A in the front face 13a of the sheet 13 and the position of the print area B in the reverse face 13b thereof are set to be coincident with each other. More specifically, the entire area in the width direction of the sheet 13 is included in the print area A and print area B; meanwhile in the lengthwise direction of the sheet 13 (same direction as the transport direction X in FIG. 1), the print area A and print area B are set inside of the leading edge 13c and the trailing edge 13d.

Moreover, the printing transport unit 21 further transports the sheet 13 in which printing has been performed on both the front face and the reverse face thereof to the downstream side in the transport direction X, and stops the transporting of the sheet 13 when part of the sheet 13 being transported has reached the cutting mechanism 16. Then, the cutting mechanism 16 performs the shearing operation in which the movable blade 66 is moved from the standby position to the cutting position so as to cut off an end portion at the trailing edge 13d of the sheet 13 (an edge positioned on the downstream side in the transport direction X when printing is performed on the reverse face 13b).

To be more specific, as shown in FIG. 2, the cutting mechanism 16 stands by in a state in which the movable blade 66 is located at the standby position so that neither the fixed blade 65 nor the movable blade 66 intersects the main transport surface 35. With this, when the sheet 13 is transported by the printing transport unit 21, the sheet 13 is supported by the first guide portion 61 to be transported along the main transport surface 35, and is stopped in a state in which the trailing edge 13d of the sheet 13 is inserted between the fixed blade 65 and the movable blade 66. In other words, the leading edge 13c side in the lengthwise direction of the sheet 13 (a side positioned on the upstream side in the transport direction X when the tailing edge 13d is cut) is supported by the first guide portion 61, whereby the sheet 13 is supported to be transported along the main transport surface 35 and the transporting of the sheet 13 is stopped in a state in which part of the sheet 13 on the trailing edge 13d side is capable of moving from the main transport surface 35.

Next, the movable blade 66 moves to the cutting position with the forward rotation of the cutting motor 57, as shown in FIG. 3. Through this, the trailing edge 13d of the sheet 13 moves to the fixed blade 65 side while being pushed from the lower side by the cutting edge of the movable blade 66. Then, the pair of cutting blades 59 comes to pinch a cutting-target part 13e of the sheet 13 (see FIG. 5A) from both sides thereof, and performs the shearing operation to cut the sheet 13. In this embodiment, the cutting-target part 13e is set across the sheet 13 in the width direction thereof, and is also set on the print areas A and B.

Accordingly, as shown in FIG. 5C, the trailing edge 13d side of the sheet 13 from which the edge portion has been cut off, is in a state that the printing has been performed to the edge of the sheet 13. Note that a cut-off piece that has been cut off from the trailing edge 13d side of the sheet 13 is collected by the collection tray 60.

After the trailing edge 13d of the sheet 13 having been cut, the cutting motor 57 continues the forward rotation so as to move the movable blade 66 from the cutting position down to the standby position. Then, when the movable blade 66 has retreated from the main transport surface 35 to the standby position, the printing transport unit 21 transports the sheet 13 to the downstream side in the transport direction X. At this time, because the path selector 54 keeps being set to the upper side position, the sheet 13 is transported to the reverse-printing transport unit 22, and accommodated in the temporary accommodation tray 26 so that the trailing edge 13d is positioned on the deep side of the temporary accommodation tray 26.

Subsequently, when the sheet 13 is transported again to the printing transport unit 21 while being supported by the second reverse guide plate 40, the sheet 13 is reversed in a manner in which the leading edge 13c of the sheet 13 is positioned on the downstream side in the transport direction X. In addition, the sheet 13 is also reversed in a manner in which the reverse face 13b on which printing has just been performed makes contact with the transport belt 34 and the front face 13a is opposed to the nozzle formation surface 18.

However, printing has already been performed on the front face 13a of the sheet 13. Therefore, printing is not performed on the sheet 13 under control of the controller 71; then the printing transport unit 21 transports the sheet 13 to the downstream side in the transport direction X along the main transport surface 35, and stops the transporting of the sheet 13 when part of the sheet 13 being transported has reached the cutting mechanism 16.

Then, as shown in FIG. 5D, an end portion at the leading edge 13c of the sheet 13 is cut off by the cutting mechanism 16. The cutting mode at this time is the same as that in the case of the trailing edge 13d of the sheet 13 being cut. Thereafter, the movable blade 66 is made to retreat from the main transport surface 35 to the standby position, and the printing transport unit 21 and the pair of discharge rollers 53 transport the sheet 13 to the downstream side in the transport direction X with the path selector 54 being shifted to the lower side position so as to discharge the sheet 13 to the discharge tray 25.

According to the above embodiment, the following effect can be obtained.

1. In the case where, taking into consideration the deformation of the sheet 13 or the like, the pair of cutting blades 59 and the main transport surface 35 on which the sheet 13 is supported are distanced from each other, the sheet 13 moves to a different position from the main transport surface 35 while being pushed by the movable blade 66 when the sheet 13 is to be cut by the pair of cutting blades 59 performing the shearing operation. In this case, the pair of cutting blades 59 is provided being slanted so that its shearing direction is slanted with respect to the main transport surface 35. Accordingly, in comparison with a case in which the pair of cutting blades 59 is provided with its shearing direction perpendicular to the main transport surface 35, it is possible to make the sheet 13 and the shearing direction form an angle closer to a right angle. As a result, the sheet 13 can be cut finely by the shearing operation.

2. Even if a cut-off piece of the sheet 13 having been cut off remains staying on the paired cutting blades 59, since the movable blade 66 movable during the shearing operation is located on the lower side in the vertical direction, it is easier to shake off the sheet 13 than in a case in which the fixed blade 65 immovable during the shearing operation is located on the lower side in the vertical direction. Accordingly, a risk that the sheet 13 having been cut off is held on the paired blades 59 can be reduced.

3. It is possible to reduce a risk that the sheet 13 having been cut off is held on the movable blade 66 in comparison with a case in which the flank 66b as a surface that intersects with the sliding contact surface 66a as a surface extending along the shearing direction in the cutting edge of the movable blade 66, is parallel to the main transport surface 35.

4. For example, in a case in which the pair of cutting blades 59 is provided so that the movable blade 66 is arranged at a position closer to the first guide portion 61 side than the fixed blade 65 when the fixed blade 65 and the movable blade 66 are engaged with each other, the movable blade 66 performs the shearing operation pushing a part of the sheet 13 which is on the first guide portion 61 side with respect to the cutting-target part 13e of the sheet 13 when the sheet 13 is cut. In other words, a part of the sheet 13 on the opposite side of the cutting-target part 13e to the first guide portion 16 side, or a part of the sheet 13 that is to be cut off from the sheet 13 of the side supported by the first guide portion 61 will not be pushed by the movable blade 66. Therefore, there has been a possibility that a part of the sheet 13 of the side that has been cut off remains sticking to the fixed blade 65. In this respect, with the configuration of this embodiment, the pair of cutting blades 59 is provided so that the movable blade 66 is arranged at a position farther distanced from the first guide portion 61 than the fixed blade 65 when the fixed blade 65 and the movable blade 66 are engaged with each other. Accordingly, when the sheet 13 is to be cut, the movable blade 66 can push a part of the sheet 13 of the side to be cut off where the sheet 13 is not supported by the first guide portion 61, and prevent the part of the sheet 13 of the side to be cut off from remaining while sticking to the fixed blade 65. Therefore, the sheet 13 can be more appropriately cut than in the case where the pair of cutting blades 59 is provided so that the movable blade 66 is arranged at a position closer to the first guide portion 61 side than the fixed blade 65.

5. The optimum shearing direction formed by the pair of cutting blades 59 varies depending on the types of the sheet S, or the like. In this respect, with the configuration of this embodiment, it is possible to change the slant angle of the shearing direction of the paired cutting blades 59 by the cutting motor 57 and the cutter frame 58. This makes it possible to change the shearing direction for each of the sheets 13, for example, whereby the sheets 13 can be cut further finely by the shearing operation.

6. It is possible to make the shearing direction perpendicular to the surface of the sheet 13 when the fixed blade 65 and the movable blade 66 cut the sheet 13 through shearing operation. This makes it possible to further reduce a risk that the sheet 13 is torn off by the pair of cutting blades 59.

7. In the case where the sheet 13 is cut by the fixed blade 65 and the movable blade 66, jaggedness is likely to be generated on a surface on the side in contact with the fixed blade 65 of the sheet 13 due to the sheet 13 being torn off. Accordingly, in the case of simplex printing, for example, by causing the fixed blade 65 to make contact with a surface on the side of the sheet 13 where printing is not performed, it is possible to suppress the deterioration of image quality due to jaggedness on a surface on the side where printing has been performed. However, in the case of duplex printing, such a problem is present that jaggedness causes the deterioration of image quality since printing is performed on both the surfaces of the sheet 13. Moreover, in the case of frameless printing, since the cutting-target parts 13e are needed to be set on the printed image, the image quality will be further deteriorated if jaggedness is generated. In this respect, with the configuration of this embodiment, since the pair of cutting blades 59 is provided so that the shearing direction against the sheet 13 intersects with the main transport surface 35 slantingly and the sheet 13 is cut while suppressing the generation of jaggedness, it is possible to suppress the deterioration of image quality.

The aforementioned embodiment may be changed as follows.

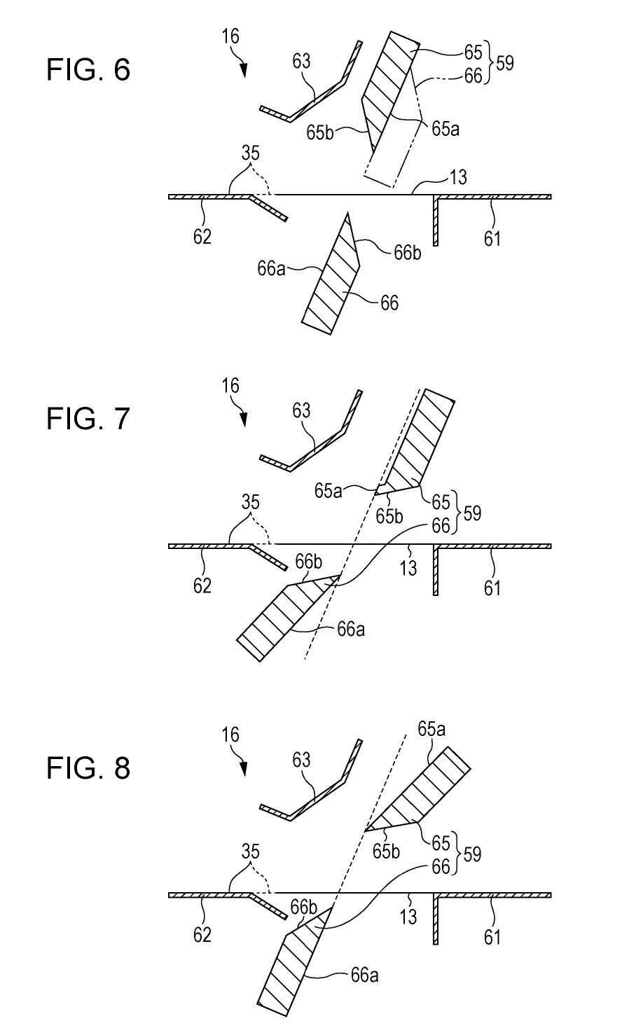

In the aforementioned embodiment, a positional relationship between the fixed blade 65 and the movable blade 66 may be changed, as shown in FIG. 6 (first variation). That is, in this first variation, the fixed blade 65 and the movable blade 66 are provided so that the movable blade 66 is arranged at a position closer to the first guide portion 61 as the support section than the fixed blade 65 at the time of shearing operation in which the movable blade 66 is located at a cutting position (position indicated by a double-dot dash line in FIG. 6) where the two blades are engaged with each other.

According to the first variation, because a cut-off piece of the sheet 13 having been cut passes through on the sliding contact surface 66a side of the movable blade 66 that is positioned on the lower side in the vertical direction, it is possible to reduce a risk that the cut-off piece is held on the movable blade 66.

In the aforementioned embodiment, the sliding contact surface 65a of the fixed blade 65 and the sliding contact surface 66a of the movable blade 66 need not slide on each other, and the fixed blade 65 and the movable blade 66 can respectively change the shape and slant of their cutting edge as desired, as shown in FIGS. 7 and 8 (second and third variations). In other words, by moving the movable blade 66 so that the cutting edge thereof moves along a shearing direction indicated by a dotted line in FIG. 7 or 8, the sheet 13 can be cut like in the aforementioned embodiment. Note that the movable blade 66 is provided being slanted with respect to the shearing direction in the second variation shown in FIG. 7. Meanwhile, in the third variation shown in FIG. 8, the fixed blade 65 is provided being slanted with respect to the shearing direction. In addition, like in the second variation shown in FIG. 7, the sliding contact surface 65a of the fixed blade 65 may be shortened in the shearing direction, for example.

In the aforementioned embodiment, the shearing direction angle of the pair of cutting blades 59 may not be changeable, but may be fixed. In this case, the shearing direction angle can be freely set within the set angle range S, in which the shearing direction is not necessarily needed to be perpendicular to the surface of the sheet 13 when the pair of cutting blades 59 applies a shearing force to the sheet 13.

In the aforementioned embodiment, the controller 71 may store the shearing direction angles of the paired cutting blades 59 associating to the types of the sheets 13, and may change the shearing direction angle of the paired cutting blades 59 in accordance with the type of the sheet 13 based on the information inputted from the operation unit 72.

In the aforementioned embodiment, the shearing direction angle of the paired cutting blades 59 may be manually changed. In other words, neither the cutting motor 57 nor the cutter frame 58 is included in the configuration. Further, movement of the movable blade 66 along the shearing direction during the shearing operation may be manually carried out.

In the aforementioned embodiment, the flank 66b as a surface that intersects with the surface along the shearing direction (the sliding contact surface 66a in the embodiment) in the cutting edge of the movable blade 66, may be formed in a shape parallel to the main transport surface 35 in a state in which the movable blade 66 is provided being slanted. Further, since the sheet 13 can be cut if the shearing force can be applied thereto, it is not necessary for the cutting edges of the fixed blade 65 and the movable blade 66 to be acute-angled. For example, in the case where the sheet 13 is weak in rigidity, the sheet 13 can be cut even if the shape of the cutting edge is right-angled or obtuse-angled.

In the aforementioned embodiment, the fixed blade 65 may be disposed on the lower side in the vertical direction of the main transport surface 35, and the movable blade 66 may be disposed on the upper side in the vertical direction of the main transport surface 35.

In the aforementioned embodiment, the surface shape, the supporting method, and the like of the first guide portion 61 can be changed as desired as long as the first guide portion 61 can support the sheet 13 along the main transport surface 35. For example, the upper surface of the first guide portion 61 may be provided with concavities and convexities, and the sheet 13 may be supported by the convexities. Further, the first guide portion 61 may support the sheet 13 with a curved surface. Furthermore, the first guide portion 61 may support the sheet 13 by holding the sheet 13 from both the front-face and reverse-face sides thereof.

In the aforementioned embodiment, the main transport surface 35 may be a surface that intersects with the vertical direction at an angle which is not perpendicular to the vertical direction. For example, in the case where the sheet 13 is supported by being held from both the front-face and reverse-face sides, the main transport surface 35 can be set along the vertical direction. In this case, the fixed blade 65 and the movable blade 66 may be disposed at the same height in the vertical direction.

In the aforementioned embodiment, the length of the pair of cutting blades 59 in the width direction may be shorter than the width of the sheet 13. That is, the pair of cutting blades 59 may not cut off the sheet 13, but may only make a cut in the sheet 13. Even in the case where a cut is made in the sheet 13, there is a risk that the sheet 13 is torn off. Accordingly, the pair of cutting blades 59 is provided so that the shearing direction against the sheet 13 is slanted with respect to the main transport surface 35, so as to make a fine cut in the sheet 13.

In the aforementioned embodiment, as long as the fixed blade 65 is immovable at a position distanced from the main transport surface 35 at the time when the movable blade 66 passes the fixed blade 65 in a sliding manner during the shearing operation that is performed on the sheet 13, the fixed blade 65 may be capable of moving from a standby position to the above-mentioned position where the fixed blade 65 is immovable until the start of the above-mentioned time.

In the aforementioned embodiment, the cutting mechanism 16 may be configured to cut an end of the sheet 13 on the upstream side in the transport direction X. To be more specific, the fixed blade 65 is provided on the upper side of the main transport surface 35 and the movable blade 66 is provided on the lower side of the main transport surface 35 in the vertical direction. Further, the pair of cutting blades 59 is provided in the following manner: that is, the shearing direction against the sheet 13 is slanted with respect to the main transport surface 35 rather than being perpendicular thereto so that the base end side of the fixed blade 65 is closer to the second guide portion 62 and the base end side of the movable blade 66 is distanced from the second guide portion 62. In this case, the second guide portion 62 functions as the support section that supports the sheet 13.

Further, the above-described cutting mechanism may be provided together with the cutting mechanism 16 of the aforementioned embodiment. In other words, by separately providing the cutting mechanisms for respectively cutting the leading edge 13c and the trailing edge 13d of the sheet 13, it is possible to reduce the number of operations of transporting the sheet 13 using the reverse-printing transport unit 22. This makes it possible to reduce the amount of time needed for cutting the sheets 13.

In the aforementioned embodiment, a long sheet that is wound in a roll may be used as the target. In addition, a sheet, film or the like formed of resin, wood or the like, cloth, string, thread, or the like can also be used as the target. Even an inflexible target, if it is supported so as to be displaced from the main transport surface 35 through being pushed by the movable blade 66, can be expected to be used effectively as a three-dimensional target, a plate-shaped target, or the like.

In the aforementioned embodiment, the cutting mechanism 16 may be provided separately from the printer 11. In other words, for example, each of the sheets 13 on which printing has been performed by the printer 11 may be set in the cutting mechanism 16 for cutting an end portion of the sheet 13.

In the aforementioned embodiment, the recording apparatus may be a fluid ejecting apparatus that performs recording by discharging or ejecting fluid other than ink (including a liquid, a liquid-form material in which the particles of a functional material are dispersed or mixed in a liquid, a fluid-form material such as gel, and a solid that can be flowed as a fluid and can be ejected). For example, a liquid-form material ejecting apparatus that performs recording by ejecting a liquid-form material containing materials such as electrode materials and coloring materials (pixel materials) in a dispersed or dissolved state for use in the manufacture of liquid-crystal displays, EL (electroluminescence) displays and surface light emission displays, can be cited. In addition, a fluid-form material ejecting apparatus that ejects a fluid-form material such as gel (e.g., physical gel) and a particulate-matter ejecting apparatus (e.g., a toner jet recording apparatus) that ejects a solid whose example is powder (particulate matter) such as toner, can also be cited. The invention can be applied in any one of the types of fluid ejecting apparatuses mentioned above. Note that, “fluid” in this embodiment includes, for example, liquids (inorganic solvent, organic solvent, solution, liquid resin, liquid metal (metallic melt) and the like), liquid-form materials, fluid-form materials, particulate matter (including particles and powder), and so on.

Hereinafter, the technical concepts that can be understood from the aforementioned embodiment and variations will be additionally described.

In a cutting device described in the appended first aspect of the invention, a pair of cutting blades is provided so that a shearing direction formed by the pair of cutting blades against a target is slanted with respect to a reference plane rather than being perpendicular thereto in a manner in which a first cutting blade comes closer to a support section and a second cutting blade is distanced from the support section.

According to this configuration, the shearing direction formed by the pair of cutting blades against the target is slanted with respect to the reference plane rather than being perpendicular thereto in the manner in which the first cutting blade comes closer to the support section and the second cutting blade is distanced from the support section. With this, in comparison with a case in which the shearing direction formed by the pair of cutting blades against the target is slanted with respect to the reference plane rather than being perpendicular thereto in a manner in which the first cutting blade is distanced from the support section and the second cutting blade comes closer to the support section, it is possible to make the shearing direction against the target become at an angle closer to a right angle when the target is cut.

The entire disclosure of Japanese Patent Application No. 2012-092676, filed Apr. 16, 2012, is expressly incorporated by reference herein.

What is claimed is:

1. A cutting device comprising:
a support section that supports a target to be cut; and
a pair of cutting blades that cuts the target by performing a shearing operation on the target when the pair of cutting blades is in a state of pinching a cutting-target part of the target supported by the support section from both sides thereof,
wherein the pair of cutting blades is configured of a first cutting blade that is immovable during the shearing operation and a second cutting blade that is movable during the shearing operation,
the support section supports the target in a manner in which the target is moved along a reference plane that is so set as to pass through between the first and second cutting blades when these two blades are not being engaged, and also supports the target so that the target can move from the reference plane when the cutting-target part of the target is pushed from a direction intersecting with the reference plane, and
the pair of cutting blades is provided so that a shearing direction thereof against the target intersects slantingly with the reference plane.

2. The cutting device according to claim 1,
wherein, of the pair of cutting blades, the first cutting blade is provided on the upper side of the reference plane and the second cutting blade is provided on the lower side of the reference plane in the vertical direction.

3. The cutting device according to claim 1,
wherein the second cutting blade is formed so that a surface that intersects with a surface extending along the shearing direction in a cutting edge of the second cutting blade is slanted with respect to the reference plane.

4. The cutting device according to claim 1,
wherein the pair of cutting blades is provided so that the second cutting blade is arranged at a position farther distanced from the support section than the first cutting blade when the two cutting blades are engaged with each other.

5. The cutting device according to claim 1, further comprising:
an angle changing mechanism that changes a slant angle of the shearing direction formed by the pair of cutting blades against the target.

6. The cutting device according to claim 1,
wherein the pair of cutting blades is provided so that, when the target that has been moved being pushed by the second cutting blade makes contact with the first cutting blade, the shearing direction is perpendicular to the surface of the target which is in contact with the second cutting blade.

7. A recording apparatus comprising:
the cutting device according to claim 1;
a recording unit that performs recording on the target; and
a transport section that transports the target so that the target is moved between the recording unit and the cutting device.

8. A recording apparatus comprising:
the cutting device according to claim 2;
a recording unit that performs recording on the target; and
a transport section that transports the target so that the target is moved between the recording unit and the cutting device.

9. A recording apparatus comprising:
the cutting device according to claim 3;
a recording unit that performs recording on the target; and
a transport section that transports the target so that the target is moved between the recording unit and the cutting device.

10. A recording apparatus comprising:
the cutting device according to claim 4;
a recording unit that performs recording on the target; and
a transport section that transports the target so that the target is moved between the recording unit and the cutting device.

11. A recording apparatus comprising:
the cutting device according to claim 5;
a recording unit that performs recording on the target; and
a transport section that transports the target so that the target is moved between the recording unit and the cutting device.

12. A recording apparatus comprising:
the cutting device according to claim 6;
a recording unit that performs recording on the target; and
a transport section that transports the target so that the target is moved between the recording unit and the cutting device.
